(19) United States
(12) Patent Application Publication
(10) Pub. No.: US 2010/0171316 A1
(43) Pub. Date: Jul. 8, 2010

(54) Rotational Generator Magnetic Assisting System

(75) Inventor: Juan Ramon Aponte-Rivera, Bayamon, PR (US)

Correspondence Address: Juan R Aponte-Rivera, URB Monte Claro Plaza 5 MA29, Bayamon, PR, 00961, US

(73) Assignee: Johel Francisco Aponte-Rodriguez, Houston, TX (US)

(21) Appl. No.: 12/576,478

(22) Filed: Oct. 9, 2009

Related U.S. Application Data
(60) Provisional application No. 61/140,929, filed on Dec. 26, 2008.

(51) Int. Cl. F03D 1/00; H02K 21/00; H02N 11/00

(52) U.S. Cl. 290/55; 310/152; 415/916

(57) ABSTRACT

An arrangement of magnets or magnetically charged materials incorporated in a fan like machinery that provides rotational driving force and further assists the electric generation, based only on the repulsion or attraction forces between magnetic fields. This system can be implemented in both horizontal axis systems as well as vertical axis systems to assist in the rotational driving forces as well as in any other oriented type of axis.

### SUMMARY

The Rotational Generator Magnetic Assisting System is basically the use of magnetic forces in both repulsion and attraction to drive rotational acceleration. This principle could be used in many ways, but the main foreseen advantage is the generation of energy without little or any need of other driving force for energy generation.

The driving force for this technology is the repulsion or attraction between the magnetic fields produced by the magnetic materials. The magnetic materials and their respective magnetic fields should be located in such a way that optimizes and favors rotational displacement towards the desired direction once interaction occurs, while at the same time this same forces do not have a negative or counter-directing interaction with the approaching rotating blade or wing. Materials with the ability to manipulate the direction of magnetic fields force directions should be used to further direct the magnetic fields in the correct direction to optimize the desired rotational drive force.

The use of this system can be used to assist wind generator technologies, as well as any other rotational equipment, by supporting the drag forces that are used to cause windmill rotations in wind farms as shown on the following schematic. The following example uses repulsion forces to assist the rotational forces. The direction, magnitude and weight of the magnetic materials should be optimized to assist rotational forces.

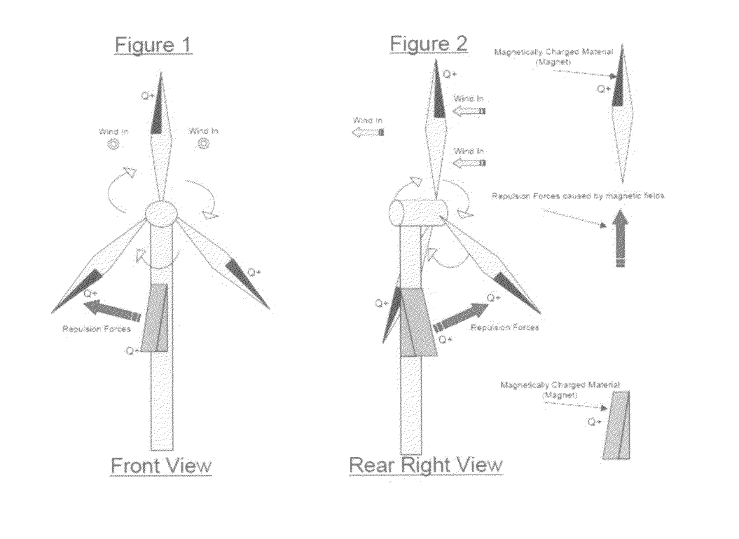

In FIG. 1 a front view illustration of the chosen example is shown to demonstrate an example of how the magnetic fields between the magnetic materials attached to the fan blades and the magnetic material attached in this case in an optimum angle at the static pole base interact to further assist or even drive rotation of the fan blades. The wind is intercepting the vertical plane while the magnetic fields are interacting at an angle shown just for illustrative purposes to promote rotation. This drawing is being presented for illustrative purposes solely since maximum acceleration will vary on the application, but the benefit of magnetic interaction to promote acceleration is displayed.

In FIG. 2 a rear right side view is illustrated of the chosen example for the subject matter. In this figure a better view can be appreciated on the fact that repulsion forces are driving or supporting the rotation of the blades and thus far generating a rotational driving force.

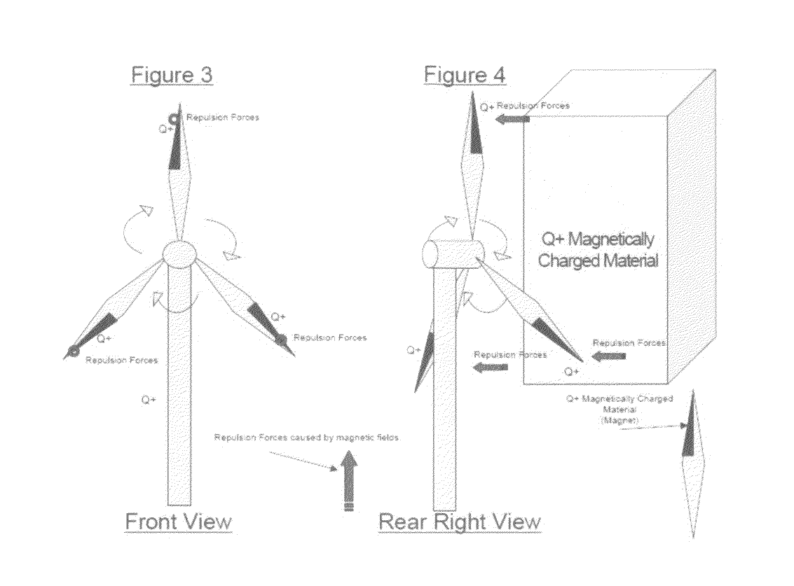

In FIG. 3 a front side view on how the subject matter drives rotation of the blades for rotational acceleration is displayed. The repulsion between both magnetic materials and their respective charges at a different angle from FIGS. 1 and 2, drives rotation without the need of any other force, such as wind. FIG. 4 illustrates the way both magnetically charged materials are facing each other to promote rotational acceleration, substituting the wind force on FIGS. 1 and 2. Both FIG. 3 and FIG. 4 are another example on how magnetically charged materials can be used to promote rotational drive.

1. The use of magnetic interaction (Repulsion or Attraction) between materials to support displacement and acceleration in a favorable direction to support electric generation in wind driven power generators.

2. In addition to claim 1, the subject matter is independent from the axis orientation of the generator components as long as the principle of magnetic interaction is favorably located supporting acceleration and displacement by repulsion or attraction.
